(19) United States
(12) Patent Application Publication
(10) Pub. No.: US 2002/0062724 A1
(43) Pub. Date: May 30, 2002

(54) Fiberboard duct fabrication apparatus

(76) Inventors: William A. Allan, Ocala, FL (US); Samuel E. Rogers, Ocala, FL (US)

Correspondence Address: Christopher A. Hofmeister, P.O. Box 557, Hampstead, NH, 03841, US

(21) Appl. No.: 09/725,403

(22) Filed: Nov. 29, 2000

(51) Int. Cl. B26D 3/06

(52) U.S. Cl. 83/875; 83/614

(57) ABSTRACT

A fiberboard duct fabrication apparatus for cutting fiberboard duct material has a working surface for supporting the fiberboard duct material. A first, second, third and fourth pulley are located at corners of the working surface. A sliding bar is laterally movable relative to the working surface with the sliding bars angular orientation fixed by a constraining cable. The constraining cable is constrained by the first, second, third and fourth pulley located at corners of the working surface.

### BACKGROUND OF THE INVENTION

This invention relates generally to an apparatus for marking, grooving or cutting insulating materials, wood or other substances typically in panel form and, more particularly, to a fiberboard duct fabrication apparatus for the use in fabricating fiberboard duct work that is used for transmitting air in heating, ventilation and air conditioning systems for residential and commercial construction.

### SUMMARY OF THE INVENTION

The invention resides in a fiberboard duct fabrication apparatus for cutting fiberboard duct material that has a working surface for supporting the fiberboard duct material. A first, second, third and fourth pulley are located at corners of the working surface. A sliding bar is laterally movable relative to the working surface with the sliding bars angular orientation fixed by a constraining cable. The constraining cable is constrained by the first, second, third and fourth pulley located at corners of the working surface. A rule is provided to allow the operator to properly position the sliding bar relative to cuts or features of the fiberboard. A supporting edge is provided that protrudes above the working surface to allow an edge of the fiberboard to be located perpendicular or at a fixed angle relative to the sliding bar. Optional removable spacers are provided to vary the distance between the sliding bar and the work surface to allow for thickness variations in the fiberboard. In the specification and the claims, the term “cutting” is intended to be generic, including, tracing, cutting and/or grooving as the case may be where the latter expressions have not been mentioned.

### BRIEF DESCRIPTION OF THE DRAWINGS

The foregoing aspects and other features of the present invention are explained in the following description, taken in connection with the accompanying drawings, wherein:

FIG. 1 is a perspective view of the fiberboard duct fabrication apparatus according to a preferred embodiment of the subject invention;

FIG. 2 is an exploded view of the fiberboard duct fabrication apparatus according to a preferred embodiment of the subject invention;

FIG. 3 is an exploded view of a sliding bar assembly employed in a preferred embodiment of the subject invention;

FIG. 4 is an exploded view of a pulley assembly employed in a preferred embodiment of the subject invention;

FIG. 5 is a top view of a constraining cable assembly employed in a preferred embodiment of the subject invention.

### DETAILED DESCRIPTION

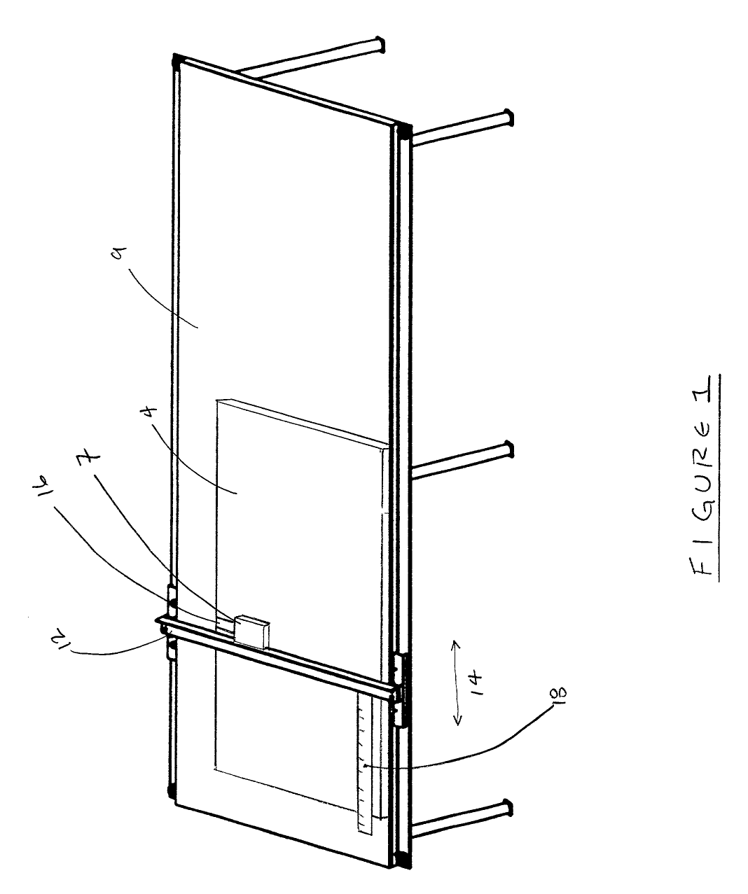

Referring now to FIG. 1 there is shown a perspective view of the fiberboard duct fabrication apparatus according to a preferred embodiment of the subject invention. Although the present invention will be described with reference to the single embodiment shown in the drawings, it should be understood that the present invention can be embodied in many alternate forms of embodiments. In addition, any suitable size, shape or type of elements or materials could be used. Fiberboard 4 is cut or grooved utilizing a duct cutter 7. Fiberboard 4 is typically available in 1 inch (25 millimeter) or 1½ inch (38 millimeter) thickness and is utilized as the base material for the fabrication of fiberboard duct for air handling applications. Duct cutter 7 is a cutting device for cutting straight cuts, miter cuts, bevel cuts, lap cuts or other various cuts required in the fabrication of fiberboard duct for air handling applications. Duct cutter 7 is commercially available from a number of manufactures including Malco International Incorporated. Fiberboard 4 is supported on working surface 9. Work surface 9 may be wood, plastic or any other material suitable for supporting Fiberboard 4. Duct cutter 7 is guided along sliding bar 12. Sliding bar 12 is shown as a straight piece of aluminum angle but may be made out of any suitable material with a straight edge to guide cutter 7. Sliding bar 12 may alternately simply be a straight edge. Sliding bar 12 is movable laterally in direction 14. Sliding bar 12 is typically held stationary by the operator in order to cut groove 16 in fiberboard 4 with duct cutter 7. Rule 18 is attached to sliding bar 12 in order to allow the operator to properly position sliding bar 12 relative to cuts or features of fiberboard 4. Rule 18 may optionally be mounted to the right of sliding bar 12 as opposed to the left which is shown in FIG. 1. Rule 18 is typically a straight edged ruler with either or both of inch or millimeter graduations on it. Rule 18 will typically be mounted such that it's zero location would coincide with groove 16. Rule 18 allows the operator to position the next parallel cut on a given piece of duct board accurately.

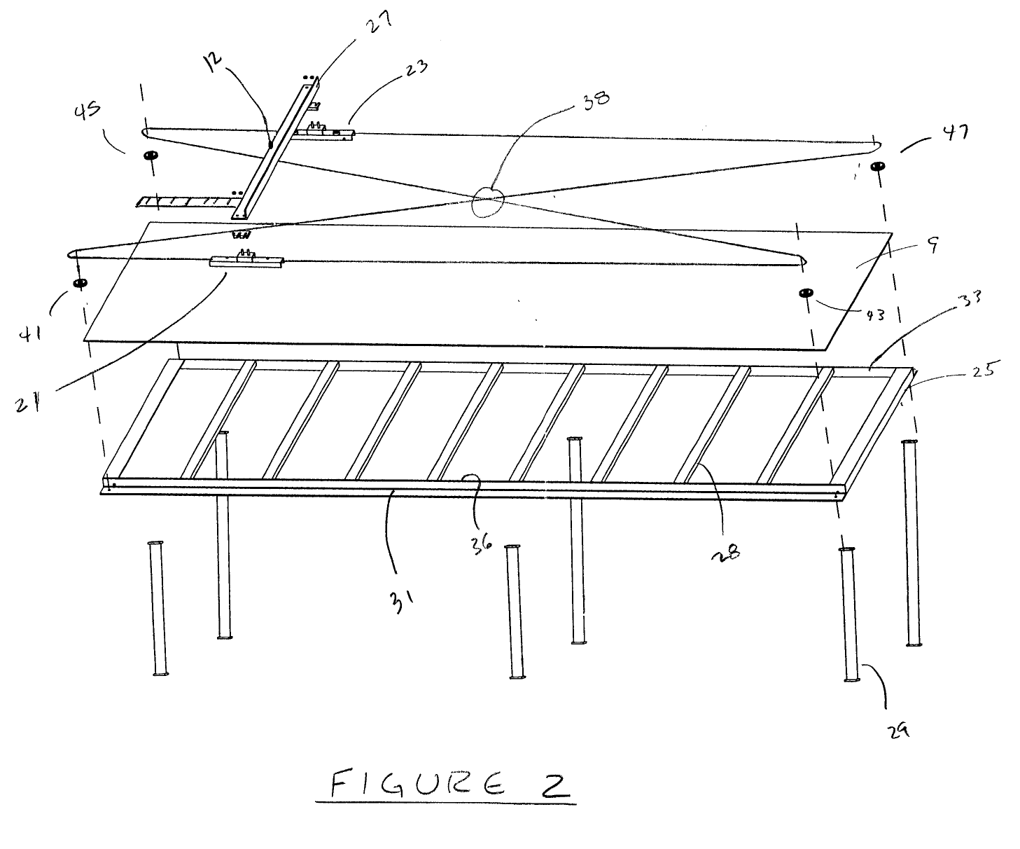

Referring now to FIG. 2 there is shown an exploded view of the fiberboard duct fabrication apparatus according to a preferred embodiment of the subject invention. Sliding bar 12 has lower roller carriage 21 and upper roller carriage 23 and duct cutter guide surface 27. Working surface 9 is supported by frame 25. Frame 25 has a plurality of supporting cross members 28, a plurality of legs 29, lower guide 31 and upper guide 33. When working surface 9 is supported by frame 25, supporting edge 36 protrudes above the working surface 9 allowing an edge of fiberboard 4 to be located relative to supporting edge 36. Constraining cable 38 is utilized to hold guide surface 27 perpendicular to supporting edge 36. Constraining cable 38 is attached to sliding bar 12 and constrained by first pulley 41, second pulley 43, third pulley 45 and fourth pulley 47. First pulley 41 and second pulley 43 are fastened to lower guide 31. Third pulley 45 and fourth pulley 47 are fastened to upper guide 33. Lower roller carriage 21 is supported by lower guide 31. Upper roller carriage 23 is supported by upper guide 33.

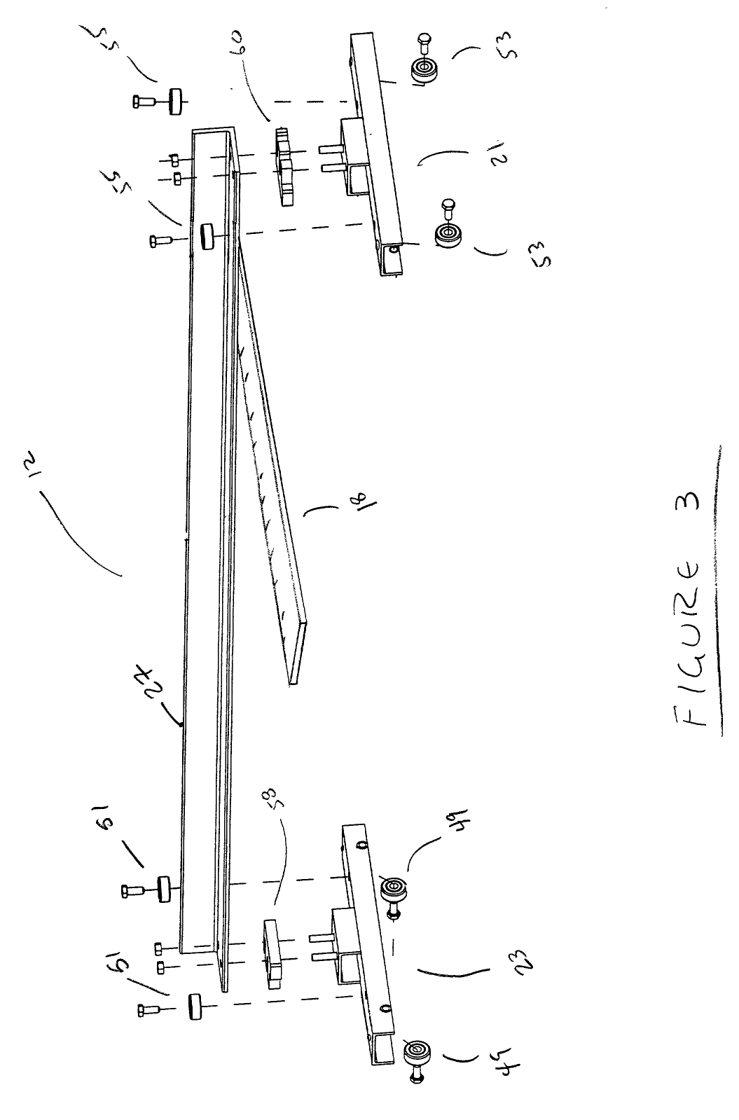

Referring now to FIG. 3 there is shown an exploded view of a sliding bar assembly employed in a preferred embodiment of the subject invention. Sliding bar 12 has lower roller carriage 21 and upper roller carriage 23, rule 18 and duct cutter guide surface 27. Rollers 49 and 51 are fastened to upper roller carriage 23 and support sliding bar 12 on upper guide 33. Rollers 53 and 55 are fastened to lower roller carriage 21 and support sliding bar 12 on lower guide 31. Rollers 55 need not be employed for satisfactory lateral movement of sliding bar 12. Removable upper spacer 58 and removable lower spacer 60 are added to increase a gap between sliding bar 12 and working surface 9 in order to accommodate varying thickness' of fiberboard 4. Rule 18 is attached perpendicular to duct cutter guide surface 27.

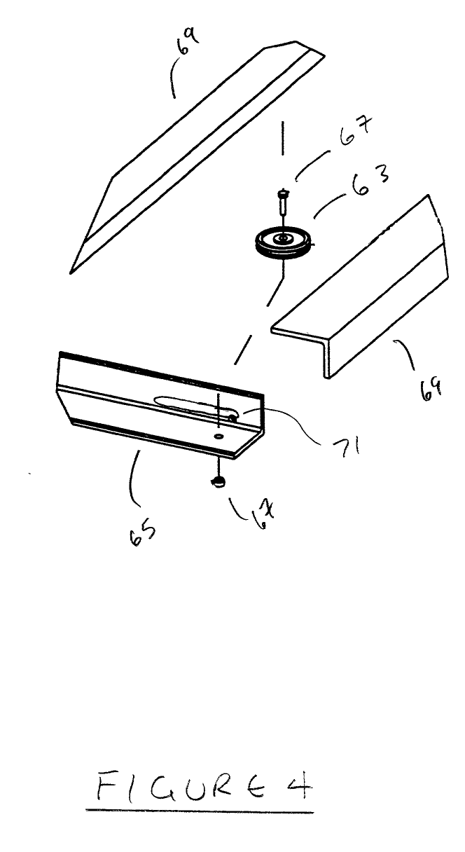

Referring now to FIG. 4 there is shown an exploded view of a pulley assembly employed in a preferred embodiment of the subject invention. The pulley assembly shown is typical for first pulley 41, second pulley 43, third pulley 45 and fourth pulley 47. Pulley 63 is fastened to guide member 65 using fasteners 67. Supporting members 69 are used to support working surface 9. Slot 71 is cut into guide member 65 in order to allow constraining cable 38 to pass under working surface 9.

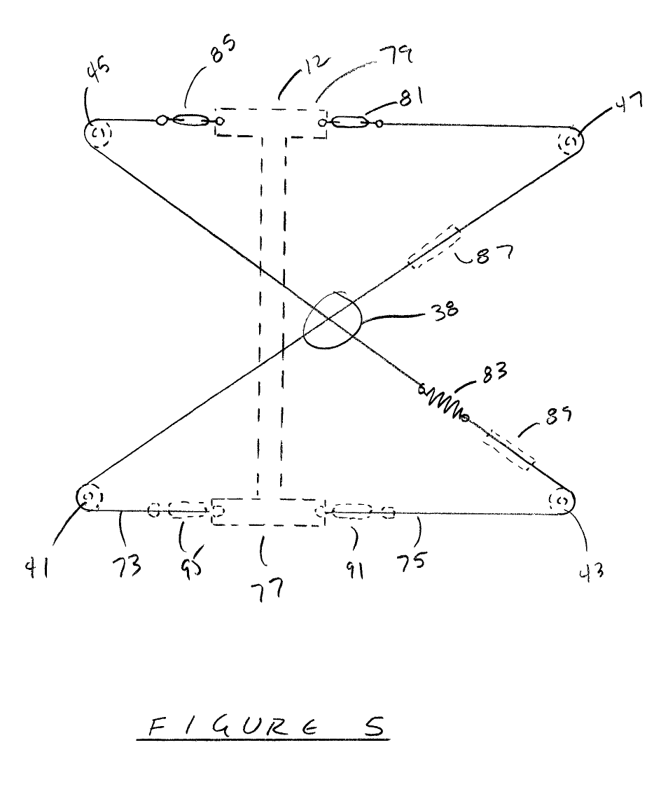

Referring now to FIG. 5 there is shown a top view of a constraining cable assembly employed in a preferred embodiment of the subject invention. First pulley 41, second pulley 43, third pulley 45 and fourth pulley 47 are shown as commercially available pulleys which may or may not include bushings or bearings. In the specification and the claims, the term “pulley” is intended to be generic, including stationary posts or stationary posts with grooves or a surface which serves the same function to constrain constraining cable 38 as the case may be where the latter expressions have not been mentioned. Constraining cable 38 has a first cable section 73 and a second cable section 75. Constraining cable 38 may be of stranded steel cable, flat steel band, polymer band, mono-filament line, string, belt material or other suitable material for a constraining cable. Sliding bar 12 has a lower end 77 and a upper end 79. First cable section 73 is coupled to lower end 77 and upper end 79 of sliding bar 12. Second cable section 75 is coupled to lower end 77 and upper end 79 of sliding bar 12. First cable section 73 is constrained by first pulley 41 and fourth pulley 47 as shown. Second cable section 75 is constrained by second pulley 43 and third pulley 45 as shown. Turnbuckle 81 may be added in order to allow tensioning of constraining cable 38. Spring 83 may be added in order to prevent over tension of constraining cable 38. A second turnbuckle 85 may be added to allow angular alignment of sliding bar 12. Spring 83, turnbuckle 81 or second turnbuckle 85 may be placed in any of a number of alternative places on constraining cable 38 to yield satisfactory results, including but not limited to positions 87, 89, 91 and/or 95. Turnbuckle 81 and turnbuckle 85 may alternately be any number of other cable or band tensioning devices available.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A fiberboard duct fabrication apparatus for cutting fiberboard duct material having a straight edge, said fiberboard duct fabrication apparatus comprising:
a fiberboard working surface for supporting said fiberboard duct material;
a first pulley proximate to a left lower corner of said working surface;
a second pulley proximate to a right lower corner of said working surface;
a third pulley proximate to a left upper corner of said working surface;
a fourth pulley proximate to a right upper corner of said working surface;
a sliding bar having a lower end and a upper end;
a constraining cable having a first cable section and a second cable section;
said first cable section coupled to said lower end and said upper end of said sliding bar;
said second cable section coupled to said lower end and said upper end of said sliding bar;
said first cable section constrained by said first pulley and said fourth pulley; and
said second cable section constrained by said second pulley and said third pulley;
wherein said sliding bar is laterally moveable relative to said fiberboard working surface and said sliding bars angular orientation is fixed relative to said fiberboard working surface.

2. The fiberboard duct fabrication apparatus of claim 1 further comprising:
a lower guide and a upper guide; and
said lower guide and said upper guide are fixed parallel to said working surface;
wherein said lower guide and said upper guide are adapted to support said lower end and said upper end of said sliding bar.

3. The fiberboard duct fabrication apparatus of claim 2 wherein:
said lower end of said sliding bar further comprises a lower roller carriage;
said upper end of said sliding bar further comprises a upper roller carriage;
said lower roller cage having a plurality of rollers for rolling on said lower guide; and
said upper roller cage having a plurality of rollers for rolling on said upper guide;

4. The fiberboard duct fabrication apparatus of claim 3 further comprising:
a removable lower spacer coupled between said lower roller carriage and said sliding bar; and
a removable upper spacer coupled between said upper roller carriage and said sliding bar;
wherein addition of said removable lower spacer and said removable upper spacer increases a gap between said duct cutter guide and said fiberboard working surface.

5. The fiberboard duct fabrication apparatus of claim 1 further comprising a rule coupled to said sliding bar.

6. The fiberboard duct fabrication apparatus of claim 5 wherein:
said rule further comprises a zero location;
said rule is fixed perpendicular to said sliding bar; and
said zero location located at a cutting edge of said duct cutter.

7. The fiberboard duct fabrication apparatus of claim 1 further comprising:
a first turnbuckle attached in line with said first cable section for adjusting tension of said constraining cable; and
a second turnbuckle attached in line with said second cable section for adjusting tension of said constraining cable.

8. The fiberboard duct fabrication apparatus of claim 1 further comprising a spring attached in line with either said first cable section or said second cable section for preventing over tension of said constraining cable.

9. A fiberboard duct fabrication apparatus for cutting fiberboard duct material having a straight edge, said fiberboard duct fabrication apparatus comprising:
a fiberboard working surface for supporting said fiberboard duct material;
a supporting edge for parallel location of said straight edge of said fiberboard duct material to said supporting edge;
said supporting edge located fixed relative to said fiberboard working surface;
a first pulley proximate to a left lower corner of said working surface;
a second pulley proximate to a right lower corner of said working surface;
a third pulley proximate to a left upper corner of said working surface;
a fourth pulley proximate to a right upper corner of said working surface;
a sliding bar having a lower end and a upper end;
a constraining cable having a first cable section and a second cable section;
said first cable section coupled to said lower end and said upper end of said sliding bar;
said second cable section coupled to said lower end and said upper end of said sliding bar;
said first cable section constrained by said first pulley and said fourth pulley; and
said second cable section constrained by said second pulley and said third pulley;
wherein said sliding bar is laterally moveable in a direction parallel to said supporting edge and said sliding bars angular orientation is fixed relative to said supporting edge.

10. The fiberboard duct fabrication apparatus of claim 9 further comprising:
a lower guide and a upper guide; and
said lower guide and said upper guide are fixed parallel to said working surface;
wherein said lower guide and said upper guide are adapted to support said lower end and said upper end of said sliding bar.

11. The fiberboard duct fabrication apparatus of claim 10 wherein:
said lower end of said sliding bar further comprises a lower roller carriage;
said upper end of said sliding bar further comprises a upper roller carriage;
said lower roller cage having a plurality of rollers for rolling on said lower guide; and
said upper roller cage having a plurality of rollers for rolling on said upper guide;

12. The fiberboard duct fabrication apparatus of claim 11 further comprising:
a removable lower spacer coupled between said lower roller carriage and said sliding bar; and
a removable upper spacer coupled between said upper roller carriage and said sliding bar;
wherein addition of said removable lower spacer and said removable upper spacer increases a gap between said duct cutter guide and said fiberboard working surface.

13. The fiberboard duct fabrication apparatus of claim 9 further comprising a rule coupled to said sliding bar.

14. The fiberboard duct fabrication apparatus of claim 13 wherein:
said rule further comprises a zero location;
said rule is fixed perpendicular to said sliding bar; and
said zero location located at a cutting edge of said duct cutter.

15. The fiberboard duct fabrication apparatus of claim 9 further comprising:
a first turnbuckle attached in line with said first cable section for adjusting tension of said constraining cable; and
a second turnbuckle attached in line with said second cable section for adjusting tension of said constraining cable.

16. The fiberboard duct fabrication apparatus of claim 9 further comprising a spring attached in line with either said first cable section or said second cable section for preventing over tension of said constraining cable.

17. A fiberboard duct fabrication apparatus for cutting fiberboard duct material having a straight edge, said fiberboard duct fabrication apparatus comprising:
a fiberboard working surface for supporting said fiberboard duct material;
a first pulley proximate to a left lower corner of said working surface;
a second pulley proximate to a right lower corner of said working surface;
a third pulley proximate to a left upper corner of said working surface;
a fourth pulley proximate to a right upper corner of said working surface;
a sliding bar having a lower end and a upper end;
said sliding bar having a duct cutter guide for guiding a duct cutter a constraining cable having a first cable section and a second cable section;
said first cable section coupled to said lower end and said upper end of said sliding bar;
said second cable section coupled to said lower end and said upper end of said sliding bar;
said first cable section constrained by said first pulley and said fourth pulley; and
said second cable section constrained by said second pulley and said third pulley;
wherein said sliding bar is laterally moveable relative to said fiberboard working surface and said sliding bars angular orientation is fixed relative to said fiberboard working surface.

18. The fiberboard duct fabrication apparatus of claim 17 further comprising:
a lower guide and a upper guide; and
said lower guide and said upper guide are fixed parallel to said working surface; and
wherein said lower guide and said upper guide are adapted to support said lower end and said upper end of said sliding bar.

19. The fiberboard duct fabrication apparatus of claim 18 wherein:
said lower end of said sliding bar further comprises a lower roller carriage;
said upper end of said sliding bar further comprises a upper roller carriage;
said lower roller cage having a plurality of rollers for rolling on said lower guide; and
said upper roller cage having a plurality of rollers for rolling on said upper guide;

20. The fiberboard duct fabrication apparatus of claim 19 further comprising:
a removable lower spacer coupled between said lower roller carriage and said sliding bar; and
a removable upper spacer coupled between said upper roller carriage and said sliding bar;
wherein addition of said removable lower spacer and said removable upper spacer increases a gap between said duct cutter guide and said fiberboard working surface.

21. The fiberboard duct fabrication apparatus of claim 17 further comprising a rule coupled to said sliding bar.

22. The fiberboard duct fabrication apparatus of claim 21 wherein:
said rule further comprises a zero location;
said rule is fixed perpendicular to said sliding bar; and
said zero location located at a cutting edge of said duct cutter.

23. The fiberboard duct fabrication apparatus of claim 17 further comprising:
a first turnbuckle attached in line with said first cable section for adjusting tension of said constraining cable; and
a second turnbuckle attached in line with said second cable section for adjusting tension of said constraining cable.

24. The fiberboard duct fabrication apparatus of claim 17 further comprising a spring attached in line with either said first cable section or said second cable section for preventing over tension of said constraining cable.
